(19) United States
(12) Patent Application Publication
(10) Pub. No.: US 2023/0207851 A1
(43) Pub. Date: Jun. 29, 2023

(54) Redox Ion Exchange Membranes and Applications Thereof

(71) Applicant: Monoatomics LLC, Union City, CA (US)

(72) Inventor: Kuanping Gong, Union City, CA (US)

(21) Appl. No.: 18/090,467

(22) Filed: Dec. 28, 2022

Related U.S. Application Data
(60) Provisional application No. 63/294,371, filed on Dec. 28, 2021.

(51) Int. Cl. H01M 8/1246; H01M 8/1213; H01M 4/90; C25B 1/04; C25B 13/02; C25B 13/05

(52) U.S. Cl. CPC H01M 8/1246; H01M 8/1213; H01M 4/9058; C25B 1/04; C25B 13/02; C25B 13/05; H01M 2300/0074

(57) ABSTRACT

A redox ion exchange membrane may include an electrically-conductive material; and redox-active materials associated with that material, the redox-active materials having reversible oxidation and reduction properties. The redox-active materials may be inorganic nanostructures on the electrically-conductive material. A hydrogen production device and a fuel cell device may include such a redox ion exchange membrane positioned between the cathode and anode. A method of producing hydrogen gas may include providing a cathode, an anode, and a redox ion exchange membrane positioned between the cathode and the anode, and applying electrical power to the cathode and the anode; where that applying causes simultaneous reciprocal reduction and oxidation reactions on opposite sides of the redox ion exchange membrane, such that H+ is released on one side of the redox ion exchange membrane

### CROSS REFERENCE TO RELATED APPLICATIONS

This application claims the benefit of priority to U.S. Provisional application No. 63/294,371, filed Dec. 28, 2021, which is hereby incorporated by reference in its entirety.

### FIELD OF THE INVENTION

The invention generally relates to the production of hydrogen, and more particularly to the use of a redox ion exchange membrane for hydrogen production.

### BACKGROUND

As the price of fossil fuels increases, and as concern about climate change linked to fossil fuel combustion increases, the demand for alternative energy sources has grown. One promising energy source for a green economy is hydrogen. Hydrogen can be produced from water via an electrolysis process, and when burned hydrogen produces water once again, without creating carbon compounds or other undesirable byproducts. However, the electrolysis process is energy-intensive, and to the extent that fossil fuels are burned to generate electricity for the electrolysis process, that process is unhelpful to the environment.

As renewable energy sources reach higher grid penetration, water electrolysis to produce hydrogen is a promising solution for large-scale, time-shift energy storage, as well as a promising solution for the generation of hydrogen for use as fuel. Water electrolysis can be operated either in acidic or alkaline environments, respectively, with proton exchange membrane (PEM) electrolysis and alkaline or anion exchange membrane (AEM) being the existing commercialized technologies. Notably, the former has been developed to date for high efficiency, but suffers from the high cost and scarce abundance of noble metals, while the latter has been developed to date for robust reliability rather than high efficiency.

Membrane thickness is important for PEM performance. However, a tension exists between thicker membranes, which are more durable in chemical and mechanical stress, and thinner membranes, which are more suitable for proton exchange from the anode side to the cathode side. Further, a PEM degrades in use due to the chemical environment. The intermediate radicals of peroxide or hydroperoxide act to decomposes the PEM during operation. Iron and copper ions form in the PEM due to electron collector plate decay. These ions act as an accelerating agent for intermediate radical formation, which is damaging to the PEM. Additionally, over time, platinum ions from the anode and/or cathode form a layer over the membrane via a reduction process, which decreases performance and durability.

One example of a PEM is a NAFION™ brand perfluorosulfonic acid (PFSA) membrane, of The Chemours Company of Wilmington, Del. NAFION™ brand PEMs have a well-defined porous structure, and multiple functional groups, but are expensive, and susceptible to contamination and clogging, and are subject to the disadvantages described above with regard to PEMs in general. For NAFION™ brand PEMs, acid-based electrolyte is used, and hydronium ion (proton) exchange occurs across the membrane. The exact mechanism of action of a NAFION™ brand PEM is still the subject of research. However, referring to FIG. 1, a cluster-channel or cluster-network model of the mechanism of action of a NAFION™ brand PEM is shown. A NAFION™ brand PEM has a stable PTFE backbone, with acidic sulfonic (SO₃H) groups of substantially 40 Å in diameter held within a continuous fluorocarbon lattice. Narrow channels that are substantially 10 Å in diameter interconnect the clusters. The SO₃H are so hydrophilic as to attract water molecules, which tend to solvate the SO₃H groups and dissociate the protons from the SO₃H groups. The dissociated protons “hop” from one acid site to another via the water molecules and hydrogen bonding, eventually passing through the membrane entirely.

As with PEMs in general, NAFION™ brand PEMs are used for water electrolysis in an acid electrolyte. Upon occurrence of electrochemical gas evolution reactions, protons are converted to H₂ gas at the cathode and water molecules are oxidized to O2 gas and protons at the anode. Consequently, a gradient of proton concentration evolves between the two sides of the NAFION™ brand PEM. This concentration gradient can be translated to a biased chemical potential, which drives protons from the anode side through the NAFION™ brand PEM to the cathode side.

Anion exchange membrane (AEM) electrolysis resembles PEM in that it is used for water electrolysis, but in an alkaline electrolyte, and the membrane provides ionic pathways (either H⁻ or OH⁻). Unlike PEM, AEM electrolysis eliminates the preferential usage of noble metal electrocatalysts and anti-corrosive building materials. Instead, period-4 transition metals (e.g., Fe, Co, Ni) can be used to formulate high efficient electrocatalysts (e.g., 1.0 A/cm² at 1.5 V), especially when operating at elevated temperatures.

Bipolar AEMs (e.g., FUMASEP® brand AEMs of FUMATECH BWT GmbH, Bietigheim-Bissingen, Germany) have been developed in search of high ionic conductivity and robust mechanical stability. Referring to FIG. 2, AEMs include ionic clusters in a hydrophobic matrix, where the hydrophobic materials cause the ionic clusters to aggregate and form interconnected ionic channels. AEMs are usually solid polymer electrolytes, which include hydrophobic polymers with attached functional positively charged hydrated ions and surrounding water molecules. The main function of the AEM is to transport OH⁻ anions across the membrane from the cathode to the anode. The membrane conducts anions based on interactions between the hydrophilic positively charged functional groups and the negatively charged OH⁻ anions.

Unfortunately, anion exchange membranes (AEMs) share most of the structural defects and performance degradation issues as PEMs. The degradation issue is even worse for AMEs, because their polymer backbones and functional groups can be easily attacked by OH⁻ and radicals. In addition, AEMs are also known for their relatively poor ionic conductivity, because the diffusion coefficient of OH⁻ is much lower than H⁺; a higher ion exchange capacity (IEC) is needed for this reason. However, higher IEC leads to the sacrifice of mechanical properties, due to excessive polymer swelling.

The Department of Energy has set a goal of reducing the cost of hydrogen production from $4/kg today to $1/kg by 2030. Existing technologies at or near the $4/kg cost range cannot meet that $1/kg goal. Thus, there is an unmet need for a technology that facilitates continuous high-volume production of hydrogen economically and easily.

### SUMMARY OF THE INVENTION

In the present invention, a low-cost hydrogen production system is achieved through a new type of membrane, where protons or anions are transported through that membrane via simultaneous chemical reversible reduction and oxidation, instead of via conventional chemical ion gradient driven mass transport. Such membranes can be used with both alkaline or acid electrolytes, with high efficiency and high reliability.

A redox ion exchange membrane may include an electrically-conductive material; and redox-active materials associated with that material, the redox-active materials having reversible oxidation and reduction properties.

A hydrogen production device may include a cathode, an anode, and a redox ion exchange membrane positioned between the cathode and the anode, the redox ion exchange membrane having a first surface and a second surface opposed to the first surface.

A fuel cell device may include a first electrode; a second electrode; and a redox ion exchange membrane positioned between the first and second electrodes, where the redox ion exchange membrane has a first surface and a second surface opposed to the first surface.

A method of producing hydrogen gas may include providing a cathode, an anode, and a redox ion exchange membrane positioned between the cathode and the anode, and applying electrical power to the cathode and the anode; where that applying causes simultaneous reciprocal reduction and oxidation reactions on opposite sides of the redox ion exchange membrane, such that H+ is released on one side of the redox ion exchange membrane

### BRIEF DESCRIPTION OF THE DRAWINGS

FIG. 1 is a schematic detail view of a proton exchange membrane (PEM).

FIG. 2 is a schematic detail view of an anode exchange membrane (AEM).

FIG. 3 is a schematic view of a water electrolysis system utilizing a redox ion exchange membrane.

FIG. 3A is a schematic view of an embodiment of a redox ion exchange membrane that includes an electrically-conductive material that is a generally thin, flat layer, with inorganic microstructures positioned on both sides of that layer.

FIG. 3B is a schematic view of a redox ion exchange membrane that includes an electrically-conductive material with a branching structure, with inorganic microstructures fabricated onto the surface of the material.

FIG. 3C is a schematic view of a redox ion exchange membrane that includes an electrically-conductive material composed of nanostructures of electrically-conductive materials, with inorganic microstructures that are themselves nanostructures intermixed with the nanostructures of the electrically-conductive material.

FIG. 4 is a side view of a first embodiment of the redox ion exchange membrane of FIGS. 3-3A having multiple layers.

FIG. 5 is a side view of a second embodiment of the redox ion exchange membrane of FIGS. 3-3A having multiple layers.

FIG. 6 is a flowchart showing the operation of the water electrolysis system of FIG. 3.

FIG. 7A is a schematic view of an example of the water electrolysis system of FIG. 3, utilizing RuO₂ in the redox ion exchange membrane, showing ion transport in that system.

FIG. 7B is a schematic view of an example of the water electrolysis system of FIG. 3, utilizing TiO₂ in the redox ion exchange membrane, showing ion transport in that system.

FIG. 8A is a scanning electron microscope (SEM) image of an electrochemically-pretreated TI thin film at a 2 μm resolution.

FIG. 8B is an SEM image of an electrochemically-pretreated Ti thin film at a 1 μm resolution.

FIG. 8C is an SEM image of an electrochemically-pretreated Ti thin film after a nanowire-forming hydrothermal reaction at a 2 μm resolution.

FIG. 8D is an SEM image of an electrochemically-pretreated Ti thin film after a nanowire-forming hydrothermal reaction at a 1 μm resolution.

FIG. 9A is an SEM image of a titanium felt.

FIG. 9B is an energy-dispersive spectra (EDS) of the titanium felt of FIG. 9A.

FIG. 9C is an SEM image of a titanium felt after a hydrothermal nanowire-forming reaction at a 10 μm resolution.

FIG. 9D is an EDS of the titanium felt of FIG. 9C.

FIG. 9E is an SEM image of a titanium felt after a hydrothermal nanowire-forming reaction at a 200 nm resolution.

FIG. 10A is an SEM image of titanium filter starting material composed of sintered micro-powders.

FIG. 10B is an SEM image of the titanium filter starting material of FIG. 10A after a hydrothermal nanowire-forming reaction.

FIG. 11A is an SEM image of a nickel mesh at a 10 μm resolution.

FIG. 11B is an SEM image of the nickel mesh of FIG. 11A at a 1 μm resolution.

FIG. 11C is an SEM image of a Ni(OH)₂/Ni-felt after a nanofiber-forming hydrolysis reaction of the nickel mesh of FIG. 11A at a 10 μm resolution

FIG. 11D is an SEM image of the nickel mesh of FIG. 11C at a 1 μm resolution.

FIG. 11E is an EDS of the nickel mech of FIG. 11C.

FIG. 12A is an SEM color map of an RuO₂ surface.

FIG. 12B is an SEM color map showing a TiO₂ membrane.

FIG. 12C is an SEM color map showing successful formation of RuO₂ on a TiO₂ membrane.

FIG. 12D is an EDS showing successful formation of RuO₂ on the TiO₂ membrane of FIG. 12B.

FIG. 13A is an SEM image of VO₂ nanosheets grown on a stainless steel mesh.

FIG. 13B is a zoomed-in SEM image of FIG. 13A.

FIG. 13C is an EDS showing successful formation of VO₂ nanosheets on a stainless-steel mesh.

FIG. 14 is an SEM image of a commercially-available Ti fiber felt.

FIG. 15 is an SEM image of RuO₂ and TiO₂ nanowires generated in-situ on that felt.

FIG. 16 shows deposition of Ni(OH)₂ nanosheets on a Ni filter, and electroplating of RuO₂ thin-films on TiO₂ membranes.

FIG. 17 is a representative chronoamperometric response of a Pt anode to water electrolysis with a Ti foil membrane, with and without hydrothermal oxidation

FIG. 18 is a representative chronoamperometric response to water electrolysis in 1.0M H₂SO₄ at 2.0V and 2.5V, with a Ti@TiO₂ membrane with and without a RuO₂ overlayer sandwiched between the anode and cathode electrodes.

FIG. 19 is a typical chronoamperometric response to water electrolysis at 2.8V in a H-cell device with a Ti@TiO₂ membrane.

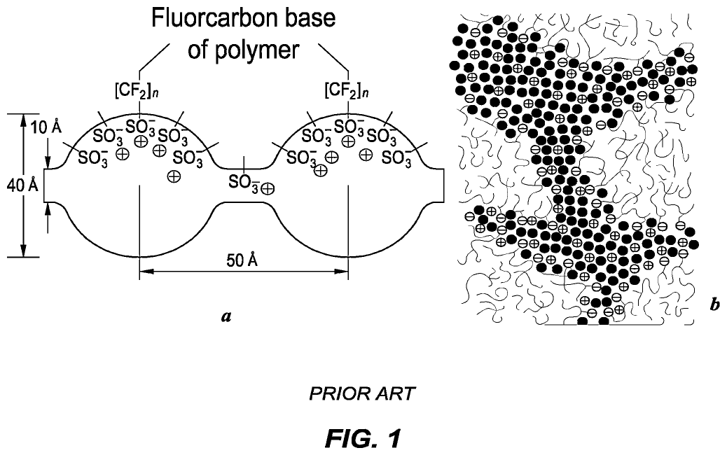

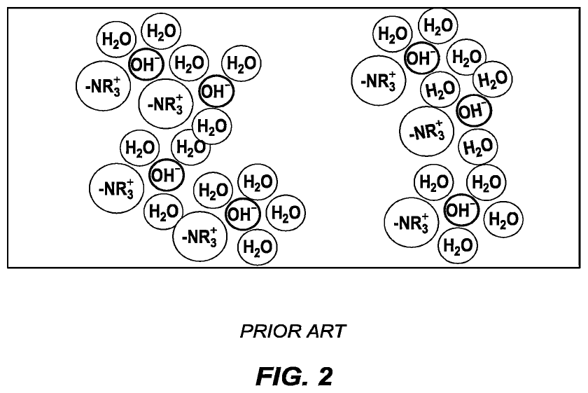

The use of the same reference symbols in different figures indicates similar or identical items.

### DETAILED DESCRIPTION

### Ion-Exchange Membrane

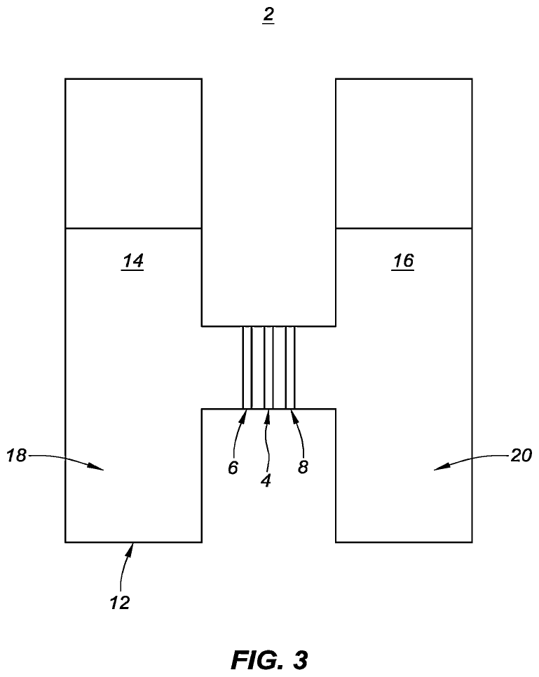

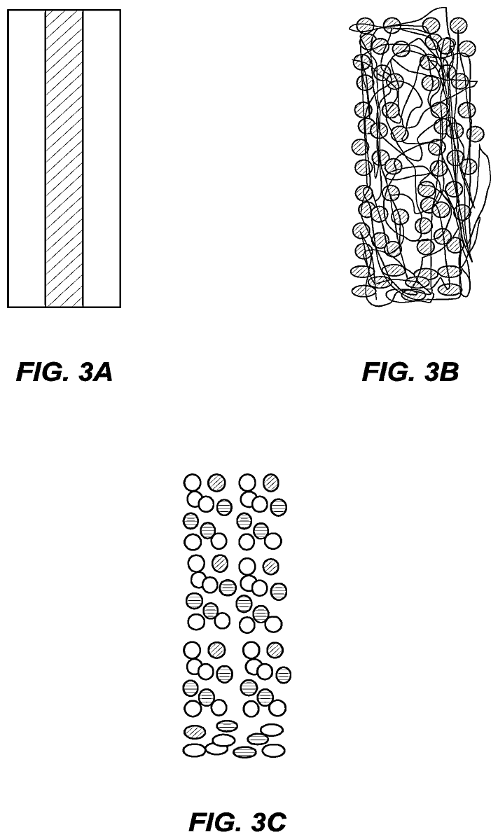

Referring to FIG. 3, an embodiment of an electrolysis system 2 is shown. A redox ion exchange membrane (RIEM) 4 is positioned between a cathode 6 and an anode 8. A power supply 10 is connected to the cathode 6 and the anode 8. The RIEM 4, cathode 6, and anode 8 are positioned in a container 12, which may be a standard electrochemical H-cell, a tub, a tube, or other structure. A first compartment 18 of the container 12 holds a first liquid 14, and the cathode 6 is exposed to the first liquid 14 in the first compartment 18. The cathode 6 may form part of a wall of the first compartment 18. A second compartment 20 of the container 12 holds a second liquid 16, and the anode 8 is exposed to the second liquid 16 in the second compartment 20. The anode 8 may form part of a wall of the second compartment 20. According to some embodiments, the first liquid 14 is different from the second liquid 16. According to other embodiments, the first liquid 14 is the same as the second liquid 16. According to some embodiments, at least one of the first liquid 14 and the second liquid 16 includes H₂SO₄. According to other embodiments, at least one of the first liquid 14 and the second liquid 16 includes KOH. According to other embodiments, at least one of the first liquid 14 and the second liquid 16 is water. The first liquid 14 and/or the second liquid 16 may be replenished periodically in use. The first liquid 14 and/or the second liquid 16 may be recirculated through the first compartment 18 and the second compartment 20, respectively.

The cathode 6 and the anode 8 may be of conventional construction, and each may be coated with any suitable catalyst. According to some embodiments, at least one of the cathode 6 and the anode 8 is a platinum coil electrode. According to other embodiments, the cathode 6 has a platinum or platinum-based coating thereon. According to other embodiments, the anode 8 has an iridium or iridium oxide coating thereon. According to other embodiments, at least one of the cathode 6 and the anode 8 has an additional, or different, coating thereon. According to other embodiments, at least one of the cathode 6 and the anode 8 does not have a coating defined thereon.

The RIEM 4 will now be described in greater detail. As used in this document, a “redox ion exchange membrane” is defined to mean a membrane that, subjected to an electromagnetic field (such as from a cathode and an anode), performs reduction and oxidation reactions simultaneously to generate protons and anions, causing those ions to penetrate the membrane in opposite directions, regardless of a concentration gradient across the membrane. Simultaneous oxidation and reduction reactions that are dependent on one another are the hallmark of a redox reaction. The oxidation reaction by itself, and the reduction reaction by itself, each may be referred to as a half-reaction, because two half-reactions occur together to form a complete redox reaction.

According to some embodiments, referring to FIGS. 3A-3C, the RIEM 4 includes inorganic nanostructures 28 on an electrically-conductive material 22. According to some embodiments, the electrically-conductive material 22 includes felt fabricated from or including at least one transition metal. According to some embodiments, the inorganic microstructures 28 include nanoparticles, nanofibers, nanotubes and nanowires. According to some embodiments, the inorganic microstructures 28 include at least one transition metal oxide. The electrically-conductive material 22 may act as a material on which inorganic nanostructures 28 are fabricated, deposited, or otherwise placed. The electrically-conductive material 22 is a portion of the RIEM 4, and the fact that the electrically-conductive material 22 is conductive does not require that the RIEM 4 as a whole is electrically conductive. Further, the electrically-conductive material 22 need not extend across the entire RIEM 4. According to some embodiments, the electrically-conductive material 22 need not be a single structure; instead, the electrically-conductive material 22 may be a plurality of individual conductive components, to which inorganic nanostructures 28 and/or other redox-active particles such as carbon black are attached. According to some embodiments, the electrically-conductive material 22 is composed at least in part of at least one of carbon dots, graphite, graphene, carbon fibers, carbon nanotubes, carbon black, Fe, Co, Ni, Ti, Mn, Zr, Cr, RuO₂, IrO₂, CrO₂, and InSnO₂.

The electrically-conductive material 22 may be continuous across the RIEM 4, or may be discontinuous. The electrically-conductive material 22 may be a plurality of independent islands across the RIEM 4. The electrically-conductive material 22 may be a single layer of material, multiple adjacent layers of material, a crystal structure, a nanostructure or nanostructure, or any other suitable structure onto which the inorganic microstructures 28 may be fabricated, grown, placed, or otherwise manufactured. Similarly, the inorganic nanostructures 28 may be continuous across the RIEM 4, or may be discontinuous. The inorganic nanostructures 28 may be a plurality of independent islands across the RIEM 4. The inorganic nanostructures 28 may be a single layer of material, multiple adjacent layers of material, a crystal structure, a nanostructure or nanostructure, and/or any other suitable structure fabricated, grown, placed, or otherwise manufactured on the electrically-conductive material 22. Referring to FIG. 3A, an embodiment of an RIEM 4 includes an electrically-conductive material 22 that is a film, foil or other generally thin, flat layer. The inorganic microstructures 28 are positioned on both sides of that layer of electrically-conductive material 22. Referring to FIG. 3B, another embodiment of an RIEM 4 includes an electrically-conductive material 22 that has a branching structure, such as but not limited to titanium. The inorganic microstructures 28 are fabricated from redox material onto the surface of the electrically-conductive material 22 in any suitable manner. Referring to FIG. 3C, another embodiment of an RIEM 4 includes an electrically-conductive material 22 that includes nanostructures of electrically-conductive materials, where the inorganic microstructures 28 are themselves nanostructures that may be intermixed with the nanostructures of the electrically-conductive material.

Titanium is a preferred transition metal for use as the electrically-conductive material 22, and titanium oxide (TiO₂) is a preferred transition metal oxide for use as the inorganic microstructures 28. However, any other transition metal or metals may be used instead of or in addition to titanium, including scandium, vanadium, chromium, manganese, iron, cobalt, nickel, copper, zinc, yttrium, zirconium, niobium, molybdenum, technetium, ruthenium, rhodium, palladium, silver, cadmium, lanthanum, cerium, praseodymium, neodymium, promethium, samarium, europium, gadolinium, terbium, dysprosium, holmium, erbium, thulium, ytterbium, lutetium, hafnium, tantalum, tungsten, rhenium, osmium, iridium, platinum, gold, mercury, actinium, thorium, protactinium, uranium, neptunium, plutonium, americium, curium, berkelium, californium, einsteinium, fermium, mendelevium, nobelium, lawrencium, rutherfordium, dubnium, seaborgium, hassium, meitnerium, darmstadtium, roentgenium, and copernicium. Further, any other oxide, oxides, chalcogenide, or chalcogenides of those transition metals may be used instead of or in additional to titanium oxide, such as but not limited to: FeO, Fe₂O₃, FeS, CoS, CoO, NiO, MnO₂, ZrO₂, and/or Cr₂O₃. Further, any salt of those transition metals may be used instead of or in additional to titanium oxide, such as but not limited to: Fe₄[Fe(CN)₆]₃, CoTiO₃, and/or LiSeO₄.

According to some embodiments, at least part of the electrically-conductive material 22 of the RIEM 4 is fabricated from a non-metallic material. Such non-metallic materials may at least one of: carbon materials (such as but not limited to carbon dots, graphite, graphene, carbon fibers, carbon nanotubes, and/or carbon black), sulfur, arsenic, selenium, boron, phosphorus, oxides of the foregoing materials (such as but not limited to A₂SO₃, SeO₂, As₂O₅, B₂O₃ and/or P₂O₅), and salts of the foregoing materials (such as but not limited to NaAsO₂, Na₂SeO₃, LiPO₄, and/or NaBO₃).

In some embodiments, a redox-active coating or layer is deposited on the electrically-conductive material 22 and/or inorganic nanostructures 28. Such a redox-active coating or layer may be either the same material or two different materials. In rare cases, upon application of a bias, a redox active layer such as an under-potential-deposited hydrogen (denoted as H_{upd}) layer can form on one side of the substrate (e.g., metal thin films). The H_{upd} layer can diffuse through the substrate to the other side. In rare cases, the surface H_{upd} layer on a metal thin-film can be viewed as a redox-active material. Further, a redox-active organic or polymer material can be added as a co-catalyst to enhance the rate and overall performance of ion transport.

At least one organic species, such as a small molecule or polymer, may be applied to the electrically-conductive material 22 and/or inorganic nanostructures 28, and/or may be applied to and/or form part of another part of the RIEM 4 as a coating. The use of at least one organic species as a coating may be useful for bonding layers of the RIEM 4 (as described below), tuning affinity for water, such as local hydrophilic or hydrophobic properties of the RIEM 4, and/or creating mechanical flexibility of the RIEM 4. Redox-active polymers and macromolecules (such as (poly)quinone, polyimide, and polypyrrole), hydrophilic and/or hydrophobic additives (such as surfactants, PTFE nanoparticles, and zwitterionic compounds), and crosslinking agents (such as glutaraldehyde, silicone gel, and interfacial polymerization) may be usefully applied to the electrically-conductive material 22.

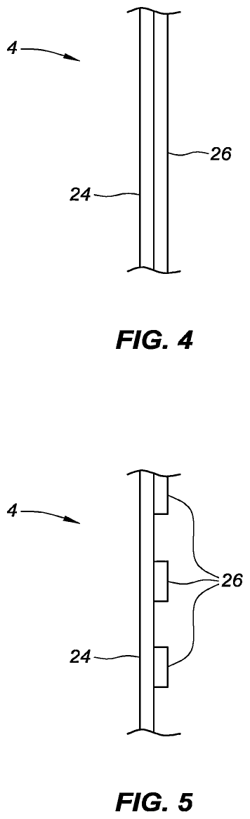

The RIEM 4 may be a single structure, or may be composed of two or more layers. Referring also to FIG. 4, the RIEM 4 includes a first layer 24 and a second layer 26. As seen in FIG. 4, the first layer 24 extends across substantially all of the second layer 26. Referring also to FIG. 5, the second layer 26 extends across only part of the first layer 24. The second layer 26 may be a plurality of independent strips across the first layer 24, or may have any other suitable shape. More layers may be utilized as needed. The use of multiple layers 24, 26 may enhance certain properties of the redox-active membrane, such as the capacity and rate of ion transport.

According to some embodiments, one of the layers 24, 26 of the RIEM 4 is a solid layer. According to some embodiments, the solid layer is a piece of foil composed of transition metal or transition metal oxide. According to some embodiments, the solid layer extends across the entire RIEM 4. According to other embodiments, the solid layer extends across part of the RIEM 4. The use of one or more solid layers in the RIEM 4 improves the separation efficiency across the redox-active membrane, such as by minimizing the crossover effect in a fuel cell. According to other embodiments, the solid layer 24 is omitted from the RIEM 4.

According to some embodiments, liquid or gel is mixed with the RIEM 4 to create a pseudo-solid electrolyte. According to other embodiments, the RIEM 4 may be completely solid, in which case the RIEM 4 is a solid electrolyte.

### Operation

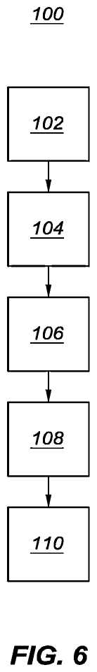

Referring also to FIG. 6, the operation 100 of an electrolysis system 2 utilizing the RIEM 4 is described. First, at block 102, the electrolysis system 2 is prepared. The first compartment 18 is filled to an appropriate level with the first liquid 14, and the second compartment 20 is filled to an appropriate level with the second liquid 16. The first liquid 14 and the second liquid 16 are heated to operational temperature. Any other preparation required for safe operation of the electrolysis system 2 is also performed.

Next, at block 104, electrical power is applied to the cathode 6 and anode 8. The amount of voltage and current applied depends on the properties of the first liquid 14 and the second liquid 16, and the properties of the RIEM 4. The proton-transporting capacity of the RIEM 4 depends on its relative potential, such that the voltage applied to the cathode 6 and anode 8 is greater than that potential to cause proton transport. Examples are provided below. The electrical power applied to the cathode 6 and anode 8 generates an electromagnetic field that is applied to the RIEM 4.

Next, at block 106, as a consequence of the application of electrical power to the cathode 6 and anode 8, and the application of an electromagnetic field to the RIEM 4, protons (hydronium ions) and anions (OH⁻ ions) are simultaneously transported across the RIEM 4. Electrons are also transported across the RIEM 4 as a consequence of the application of an electromagnetic field to the RIEM 4. The ion motion direction across the RIEM 4 is not driven by the concentration gradient across the RIEM 4. Instead, the electrochemical driving force (that is, the relative voltage against the cathode and anode) determines the transport direction and causes ions to penetrate and cross the RIEM 4. Further, electron transfer across the RIEM 4 is driven by the potential bias across the RIEM 4, therefore enabling a minimal iR drop. For example, during water electrolysis using the RIEM 4 a lower OH⁻ concentration catholyte (i.e., an acidic solution) and a high OH⁻ concentration anolyte (i.e., an alkaline solution), OH⁻ ions are transported from the cathode side to the anode side by the electrochemical driving force.

According to some embodiments, during operation of the RIEM 4, OH⁻ is neither oxidized or reduced. Instead, redox-active species in the RIEM 4 are oxidized and/or reduced, absorbing or releasing OH⁻. Similarly, according to some embodiments, during operation of the RIEM 4, H⁺ is neither oxidized or reduced. In this way, the RIEM 4 can be operated for a substantial period of time without a need to replenish the electrolyte(s) of the first liquid 14 and/or the second liquid 16. Further, operation of the RIEM 4 does not utilize ion transport across the RIEM 4. Thus, the RIEM 4 may be solid, or may include solid components, without degrading operation of the RIEM 4.

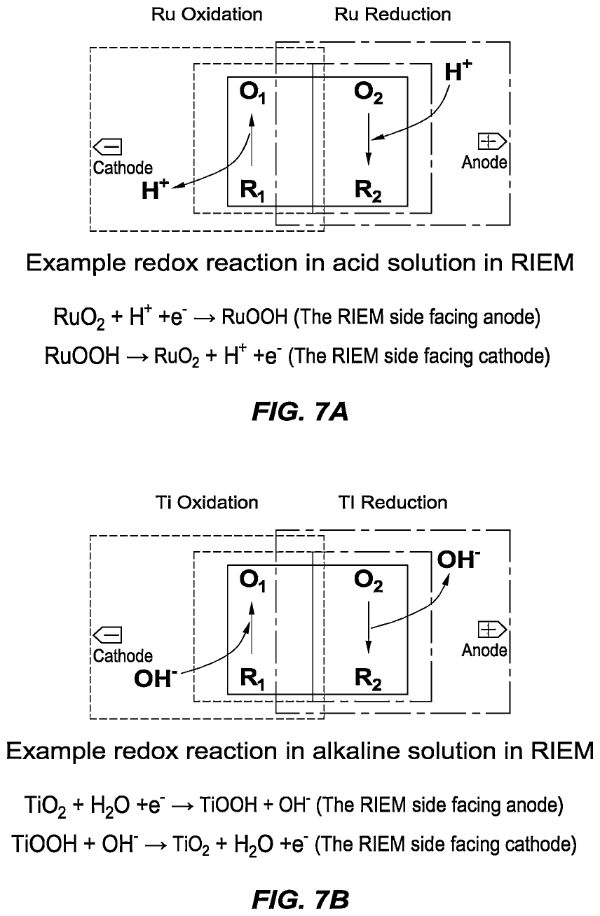

As one example, referring to FIG. 7A, an RIEM 4 is placed between a first liquid 14 and second liquid 16 that are both a solution of 1.0M H₂SO₄ in water. It will be appreciated that other solutions, such as HClO₄ and H₃PO₄ in water alone or in combination, may be used instead of or in addition to the solution of 1.0M H₂SO₄ in water. The concentration of those electrolytes in water may be varied from a 1.0M solution as well. The RIEM 4 of this example includes an electrically-conductive material 22 composed of Ti and inorganic microstructures 28 composed of RuO₂, and operates via the following reactions:
On one side of the RIEM 4, RuO₂+H⁺+e⁻→RuOOH (that is, RuO₂ is oxidized, and meanwhile, H⁺ is absorbed).
On the opposite side of the RIEM 4, RuOOH→RuO₂+H⁺+e⁻ (that is, Ru is reduced, and meanwhile, H⁺ is released).

It will be appreciated that in the above example, one reaction occurs on one side of the RIEM 4, while the opposite reaction occurs simultaneously on the opposite side of the RIEM 4. The Ti in both species TiO₂ and TiOOH changes its chemical valence—that is, the Ti in the RIEM 4 takes part in a redox reaction. However, OH⁻ is neither reduced nor oxidized, although it participates in that redox reaction.

As another example, referring to FIG. 7B, an RIEM 4 is placed between a first liquid 14 and second liquid 16 that are both a solution of 1.0M KOH in water. It will be appreciated that other solutions, such as LiOH, NaOH, RbOH and CsOH in water alone or in combination, may be used instead of or in addition to the solution of 1.0M KOH in water. The concentration of those electrolytes in water may be varied from a 1.0M solution as well. The RIEM 4 of this example includes an electrically-conductive material 22 composed of Ti and inorganic microstructures 28 composed of RuO₂, and operates via the following reactions:
On one side of the RIEM 4, TiO₂+H₂O+e⁻→TiOOH+OH⁻ (that is, TiO₂ is reduced and meanwhile, OH⁻ is released).
On the opposite side of the RIEM 4, TiOOH+OH⁻→TiO₂+H₂O+e⁻ (that is, Ti is oxidized, and meanwhile, OH⁻ is absorbed).

It will be appreciated that in the above example, one reaction occurs on one side of the RIEM 4, while the opposite reaction occurs simultaneously on the opposite side of the RIEM 4. The Ti in both species TiO₂ and TiOOH changes its chemical valence—that is, the Ti in the RIEM 4 takes part in a redox reaction. However, OH⁻ is neither reduced nor oxidized, although it participates in that redox reaction.

As described above with regard to FIGS. 7A-7B, cathode and anode reactions are coupled with oxidation and reduction at the RIEM 4, respectively. The redox reactions at the RIEM 4 are readily reversible. Further, inside the RIEM 4, spontaneous chemical reactions occur to equilibrate the chemical energy, cyclically transporting the resulting ions. That is, in operation, the RIEM 4 simultaneously reduces and oxidizes ions of interest (e.g., H⁺ and OH⁻) on both sides of the RIEM 4 under an electrical field. As one reaction absorbs the ions from its surroundings, the other reaction releases the same ions, thereby causing redox-driven ion transport (RDIT) that drives ionic motion relative to the RIEM 4. That is, applying electrical power to the cathode 6 and anode 8 causes simultaneous reciprocal reduction and oxidation reactions on opposite sides of the redox ion exchange membrane 4, such that H⁺ is released on one side of the redox ion exchange membrane 4.

Next, returning to FIG. 6, at block 108, in the first compartment 18 containing the cathode 6, protons that have migrated across the RIEM 4 acquire electrons to form hydrogen gas. Such acquisition of electrons occurs at the cathode 6, where electrons combine with H⁺ ions to form hydrogen gas.

At the end of the operation 100, at block 110, the hydrogen gas formed in the first compartment 18 is collected and stored for later use.

### Fuel Cell

It is known in the art that an electrolysis system can be run in reverse as a fuel cell. Consequently, the RIEM 4 is suitable for use in a fuel cell as well as in an electrolysis system for producing hydrogen. For example, an RIEM 4 that utilizes an electrically-conductive material 22 that is composed of Ti and inorganic nanostructures 28 that are composed of TiO₂ may be utilized in an alkaline fuel cell system. That RIEM 4 may be utilized with a first liquid 14 and second liquid 16 that are both a solution of water with 1.0M KOH, with H₂ and O₂ feeding gases. Instead of the cathode 6 and anode 8, the fuel cell includes two electrodes on opposite sides of the RIEM 4. H₂ is oxidized at the negative electrode while O₂ is reduced at the positive electrode, outputting a voltage and a current via the electrodes. The RIEM 4 is biased versus the two electrodes. Consequently, TiO₂/Ti will be reduced, while releasing OH⁻ ions, close to the side of the RIEM 4 that faces the negative electrode. As such, the TiO₂/Ti (reduced form) will be oxidized close to the other side of the RIEM 4, uptaking OH⁻ ions from its environment.

Where the RIEM 4 is used in a fuel cell with two electrodes, according to some embodiments, at least one of the electrodes is fabricated at least in part from a noble metal. A “noble metal” is any metallic or semimetallic element that does not react with a weak acid and give off hydrogen gas in the process, which is a set that includes the six platinum group metals (platinum, gold, ruthenium, rhodium, palladium, osmium, and iridium), copper, mercury, technetium, rhenium, arsenic, antimony, bismuth, polonium, and silver.

### EXAMPLES

### Example 1

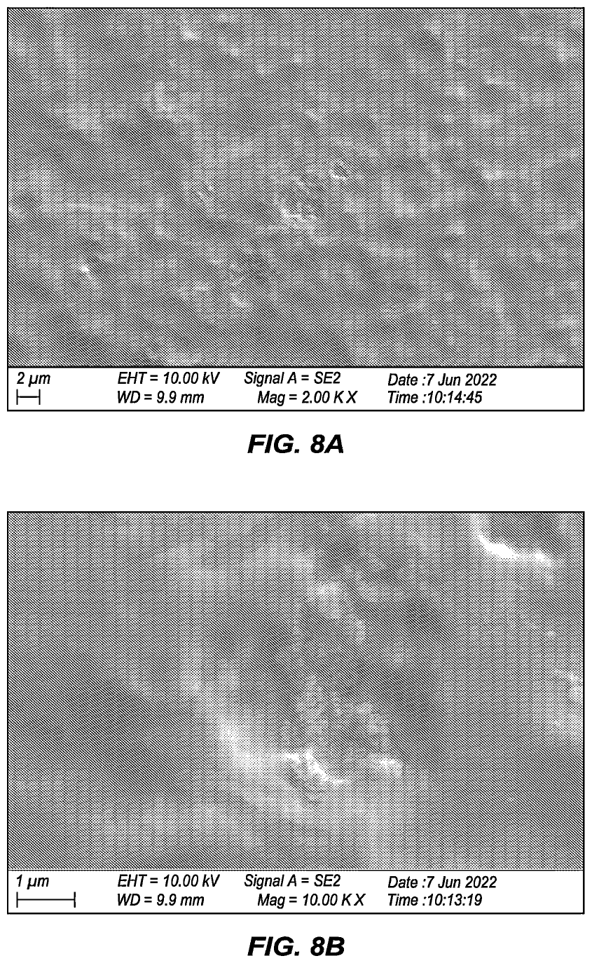

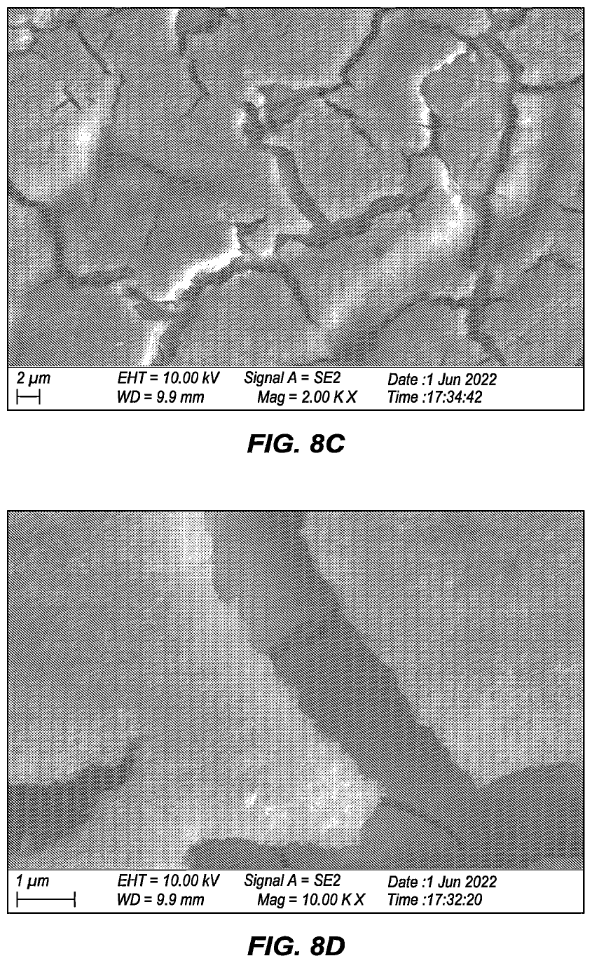

To demonstrate the concept of a RIEM 4, experiments were performed with titanium and titanium oxide. In Example 1, a commercial titanium thin film that measured 12.5 μm in thickness, the surface of which is usually covered by an oxide layer (TiO₂) on the scale of a few nanometers, was utilized as a material. To amplify the amount of the surface oxide, a titanium thin-film disc measuring 1.0 inch in diameter was subjected to a two-step procedure of treatment. That titanium thin-film disc was first electrochemically oxidized at 20.0 V for 4.0 hours in a mixture solution of 1.0M NH₄Cl and 5.0M KOH, to roughen the surface and thusly enhance the efficient surface area for the subsequent formation of TiO₂ nanostructures (FIGS. 8A-8B). Afterwards, the thin-film thusly pretreated was subjected to a hydrothermal reaction at 130° C. for 24 hours in 10.0M NaOH. FIGS. 8C and 8D show an additional layer on the titanium substrate. Further, the higher-magnification image (FIG. 8D) shows that the additional layer includes nanowires closely entangled with each other.

### Example 2

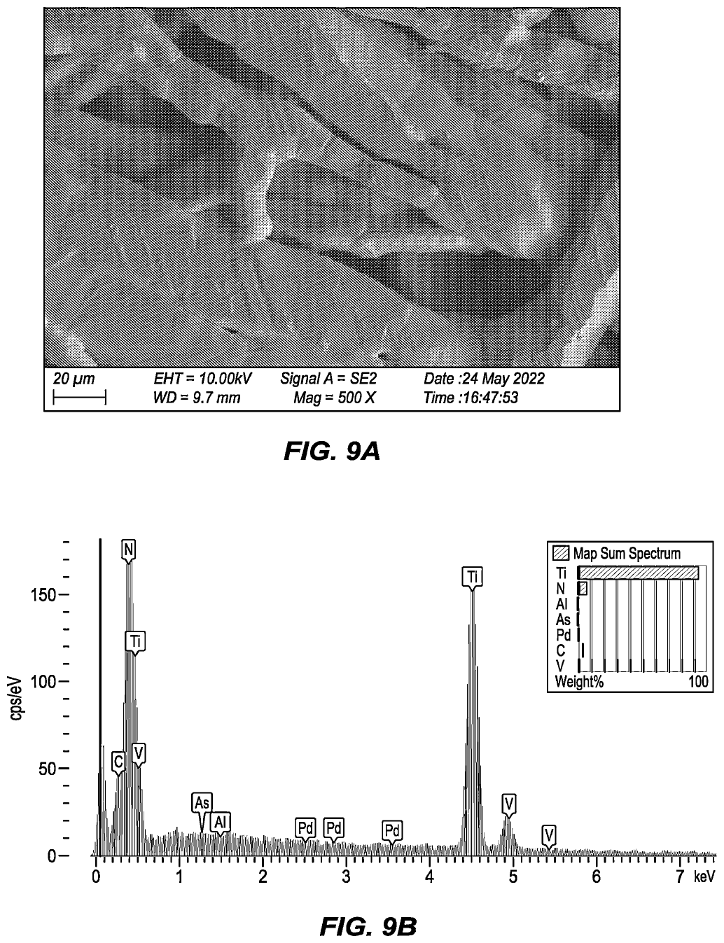

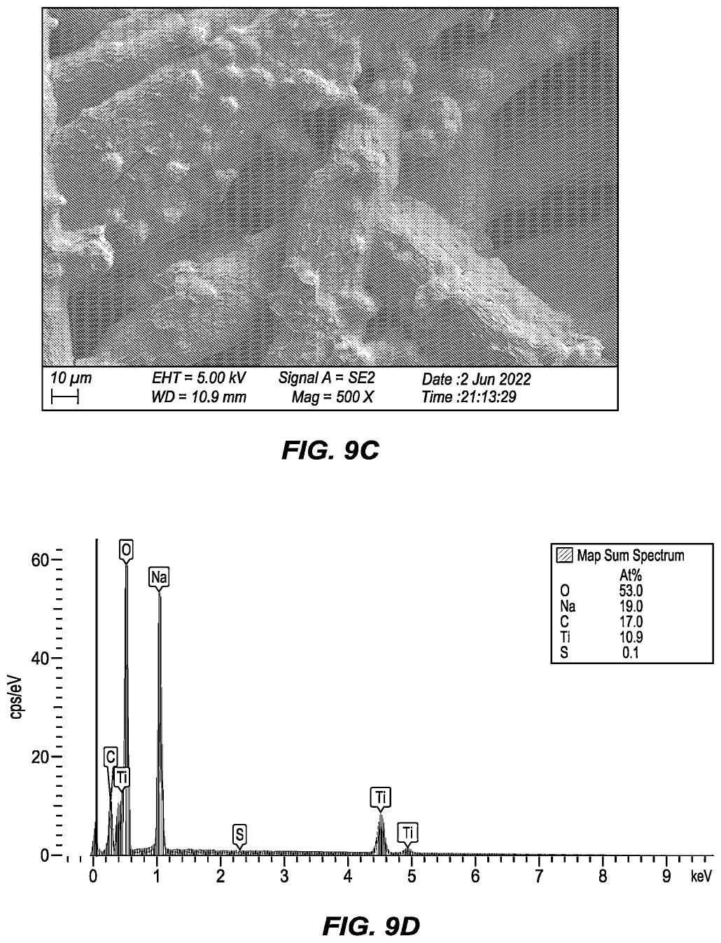

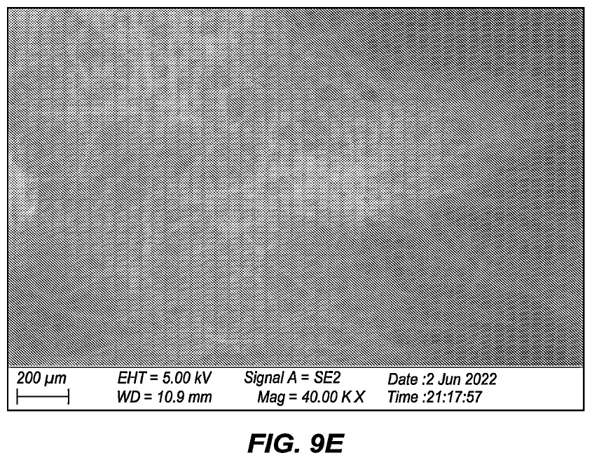

As another example of a demonstration concept of a redox-active membrane, a commercial titanium felt was cleaned by an ultrasonic bath, and subsequently further cleaned in a solution of acetone, ethanol, and deionized water. As in Example 1, the surfaces of individual titanium fibers (FIG. 9A) were converted to TiO₂ nanowires that are closely entangled with each other, by subjecting the entire felt to a hydrothermal reaction at 130° C. for 24 hours in 10.0M NaOH. FIGS. 9C and 9E show SEM images of that titanium felt after the production of TiO₂ nanowires. FIG. 9B is an EDS of the commercial Ti felt prior to treatment. FIG. 9D is an EDS of the TI felt after treatment, confirming the presence of TiO₂ nanowires.

### Example 3

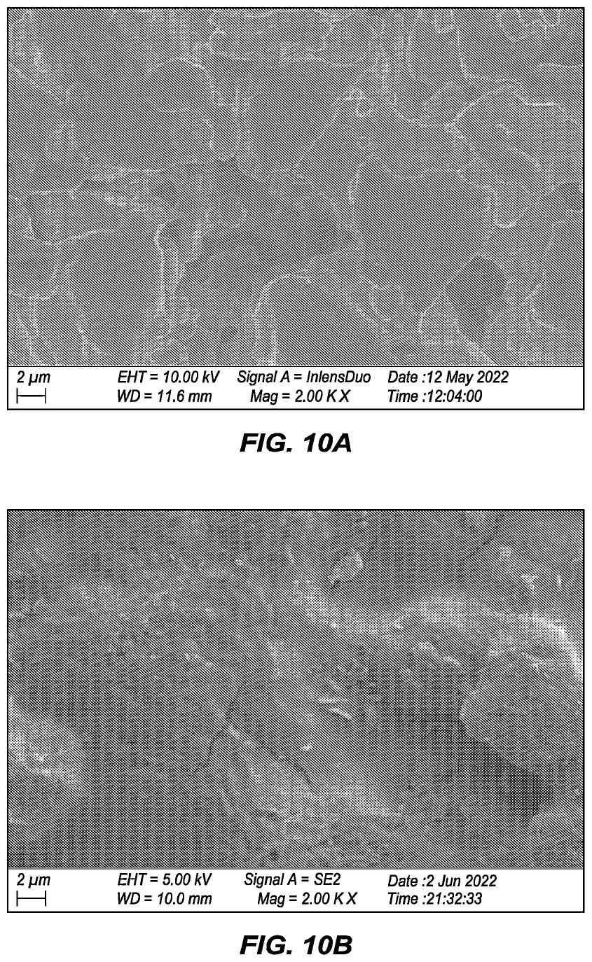

The same procedure as in Example 2 was applied to convert a commercial titanium filter to a nanoporous TiO₂/Ti-filter membrane. The titanium filter starting material was composed of sintered micro-powders (FIG. 10A). Comparison indicates that the final TiO₂/Ti-filter was composed of TiO₂ nanowires on a metallic Ti backbone (FIG. 10B).

### Example 4

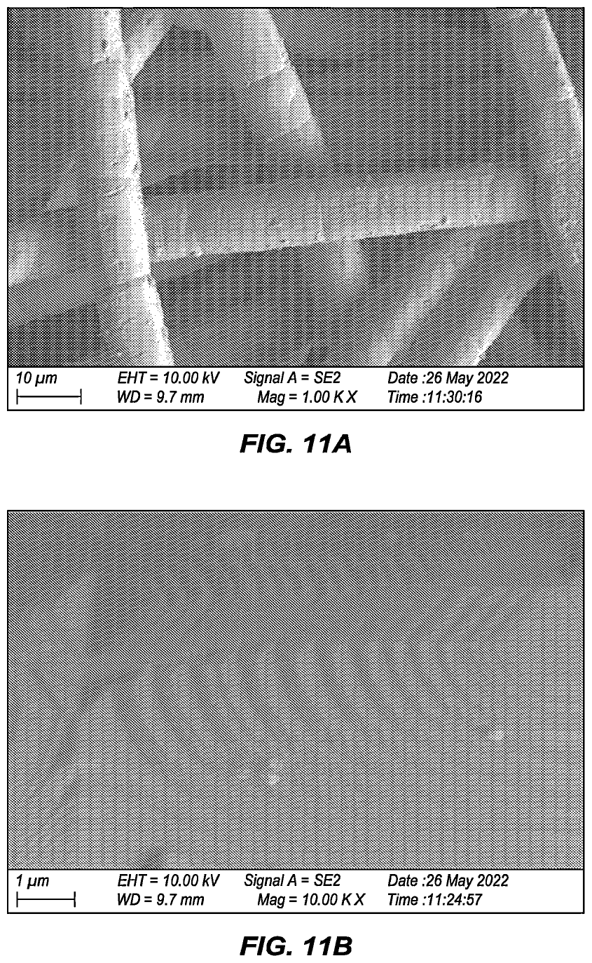

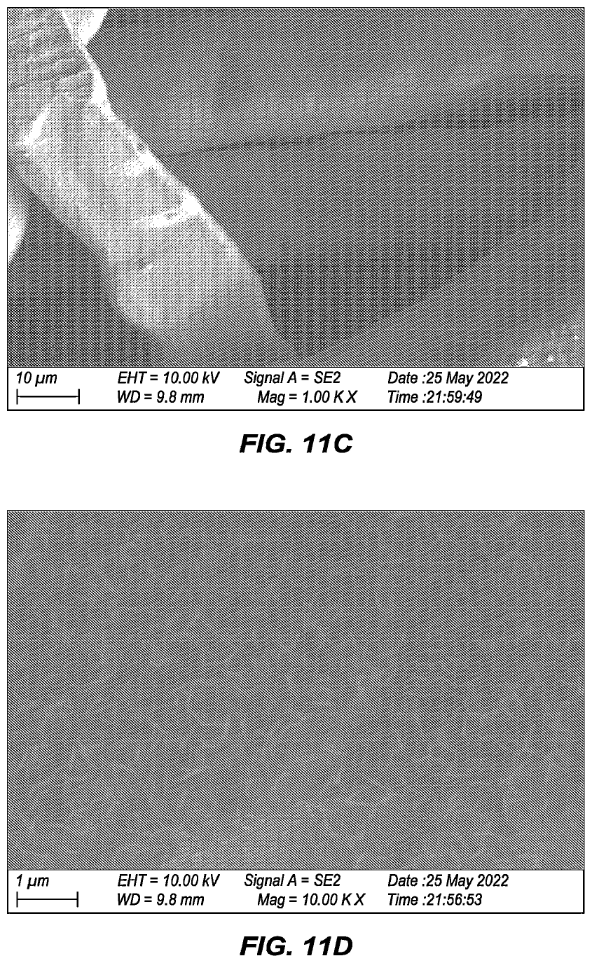

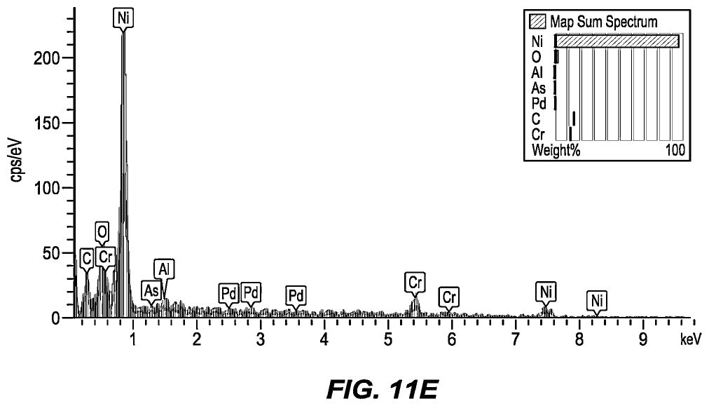

In another example, a RIEM 4 including Ni(OH)₂ was grown on a nickel mesh via an enhanced hydrolysis method at 90° C. in an aqueous solution containing 50M Ni(NO₃)₂ and 1.0M of urea. A starting material of a commercial nickel mesh included of interconnected nickel fibers of substantially 8 μm (FIGS. 11A-11B). Hydrolysis of that nickel mesh produced a final Ni(OH)₂/Ni-felt membrane in which the individual Ni fibers were modified by Ni(OH)₂ nanosheets conformably and uniformly (FIGS. 11C-11D). FIG. 11E is an EDS spectrum of the final Ni(OH)₂/Ni-felt membrane of FIGS. 11C-11D.

### Example 5

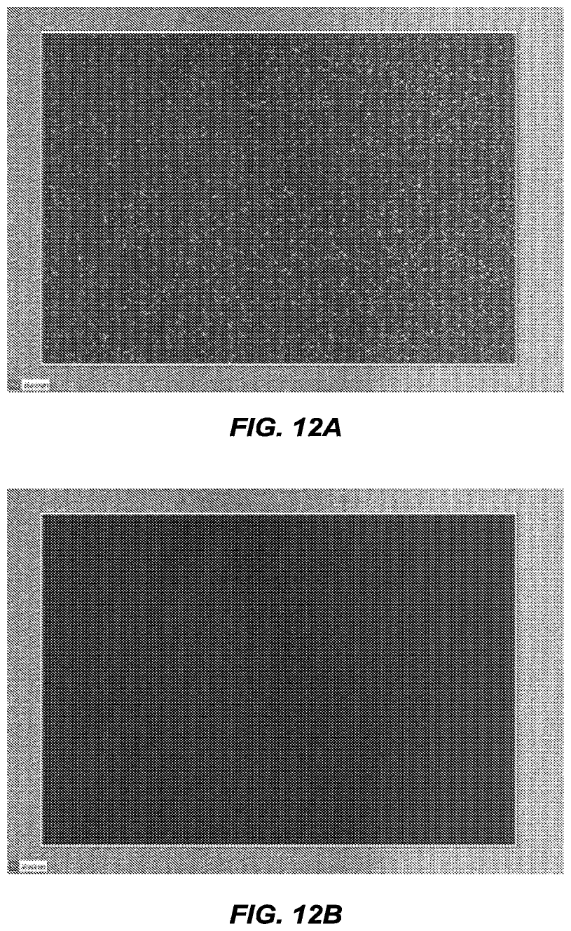

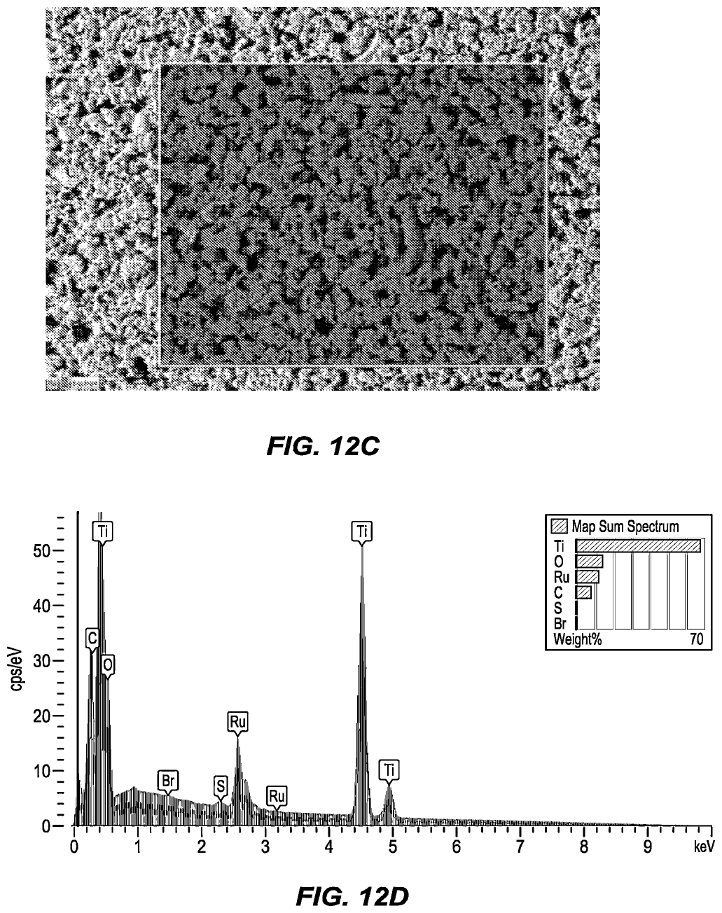

A TiO₂/Ti RIEM 4 was prepared using the same methods as in Examples 1, 2 and 3 above. RuO₂ was electrochemically deposited on the prepared TiO₂/Ti in an electrolytic bath of 0.5M H₂SO₄ and 50 mM RuCl₃. The electro-deposition was achieved in room temperature with a three-electrode system. A platinum foil and an Ag/AgCl electrode, respectively, were used as the counter electrode and the reference electrode. The electro-deposition adopted a chronoamperometric step-function, that is, −0.6 V for 5 minutes followed by −0.4 V for 0.5 minutes. All the potentials are cited against the Ag/AgCl reference electrode. The successful formation of RuO₂ on the TiO₂/Ti membrane was confirmed by SEM color mapping and EDS (FIGS. 12C-12D). FIGS. 12A-12B shows the color maps of Ru alone and Ti alone, respectively.

### Example 6

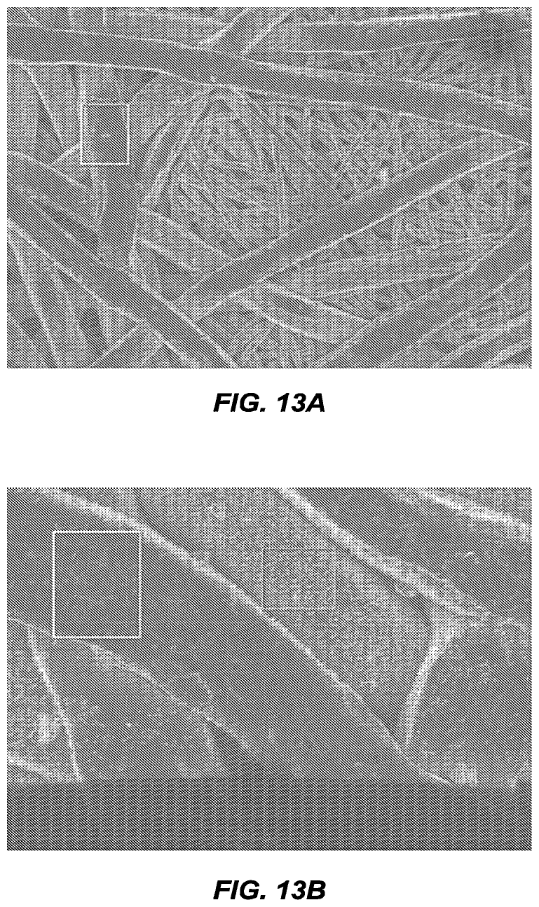

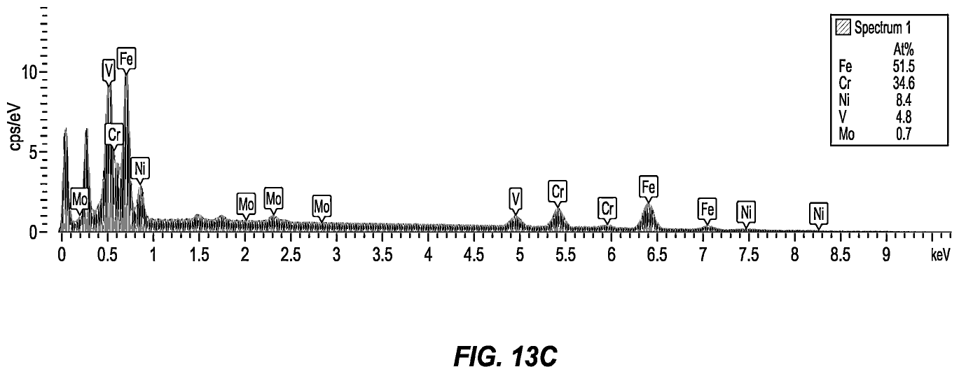

VO₂ nanosheets were grown on a stainless steel (sst) mesh membrane to form a VO₂/stainless steel (sst) membranes for potassium batteries by an electro-deposition method in room temperature with a three-electrode system. A platinum foil and an Ag/AgCl electrode were, respectively, used as the counter electrode and the reference electrode. The electrolytic bath consisted of 0.5M H₂SO₄ and 50 mM VO·SO₄·H₂O (vanadium (IV) oxide sulfate). The electrodeposition occurred at −0.75 V versus Ag/AgCl (3M KCl filled) with a variety of lengths of time. The VO₂/sst membranes were characterized by SEM (FIGS. 13A-13B) and EDS (FIG. 13C).

### Further Examples

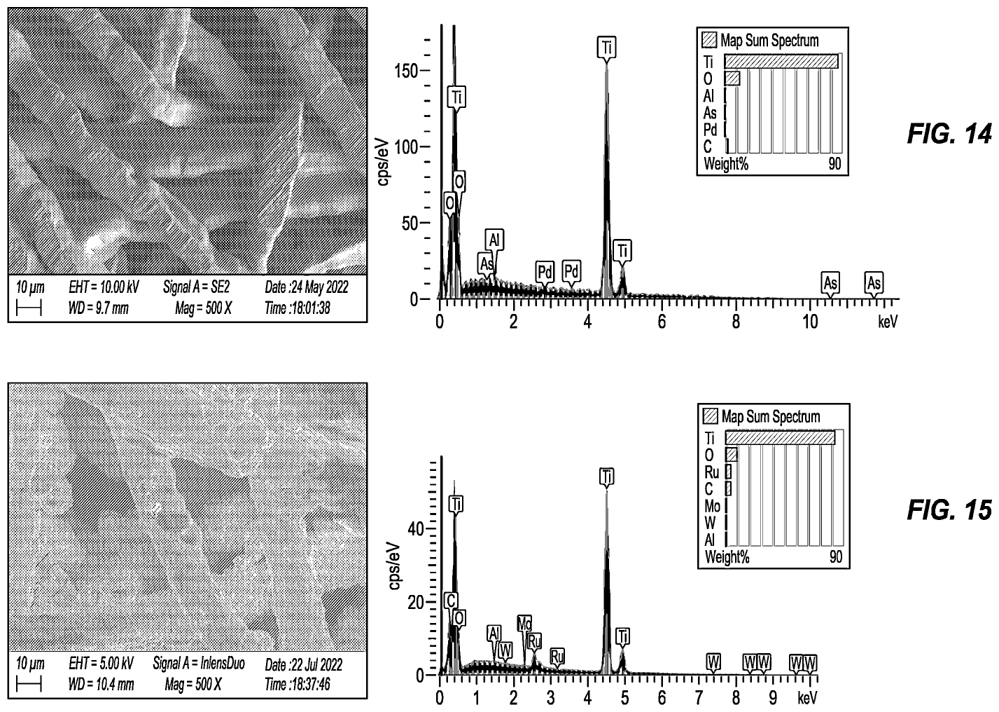

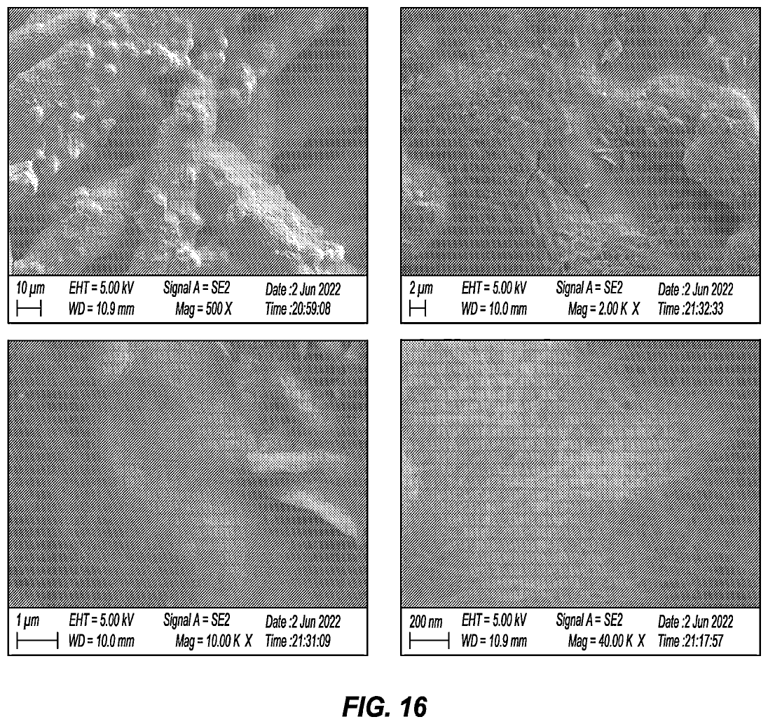

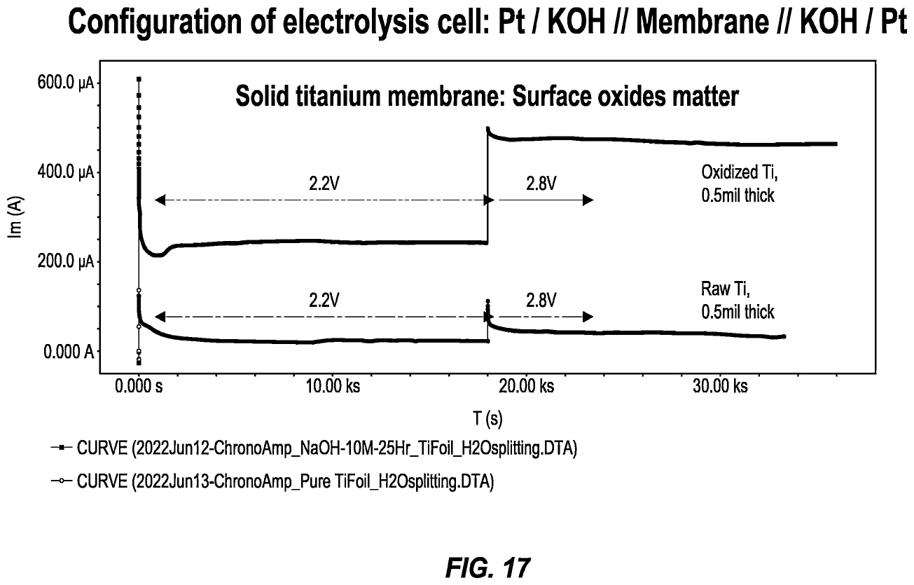

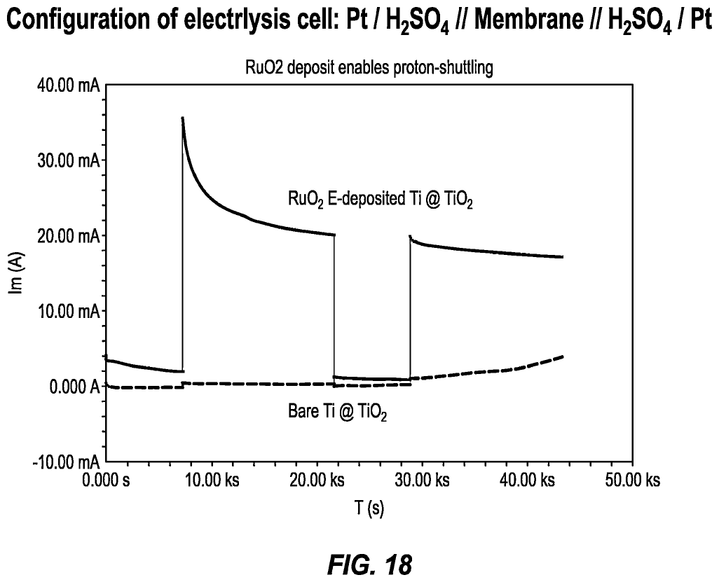

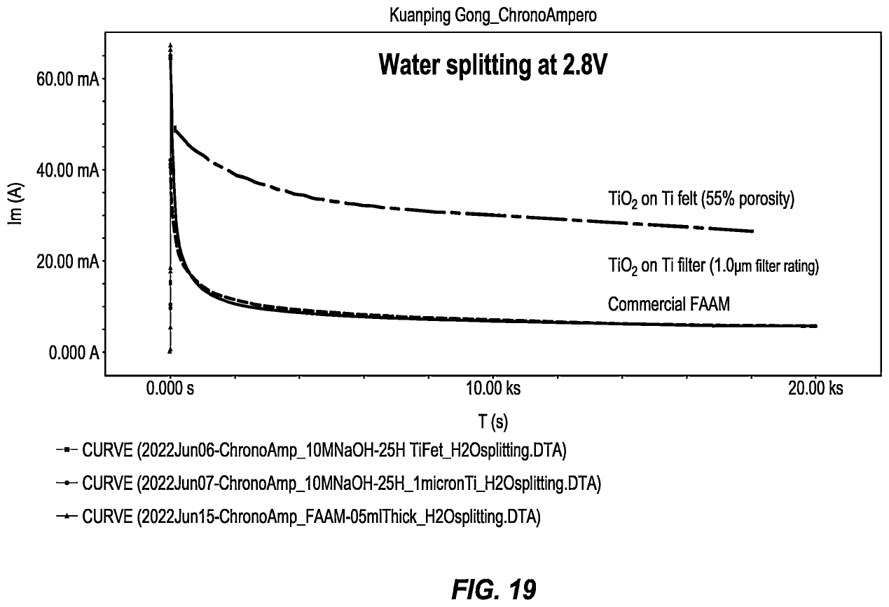

To further demonstrate the concept and the workability of the RIEM 4, nanoporous membranes were created, composed of nanoscaled metal oxides surrounding a metallic backbone. Referring to FIG. 14, an SEM image of a commercially-available Ti fiber felt is seen. Representative energy-dispersive spectra (EDS) of that Ti fiber felt is also shown in FIG. 14. Referring to FIG. 15, an SEM image of RuO₂ and TiO₂ nanowires generated in-situ on that felt is shown. Representative energy-dispersive spectra (EDS) of that material is also shown in FIG. 15. Commercially-available Ti felt was subjected to hydrothermal reactions in an aqueous solution to produce a redox-active TiO₂ nanowire layer on individual fibers of the TiO₂ felt. These TiO₂ nanowires are closely entangled on individual Ti fibers and interconnected between neighboring Ti fibers, forming a nanoporous structure. Referring to FIG. 16, deposition of Ni(OH)₂ nanosheets on a Ni filter, and electroplating of RuO₂ thin-films on TiO₂ membranes, is shown.

A RIEM 4 configured as shown in FIG. 16, including RuO₂ and TiO₂ nanowires on a Ti fiber felt, was sandwiched in a H-shaped cell at between two identical Pt electrodes (an anode and a cathode, respectively). The two-electrode system was used to conduct water electrolysis in a 1.0M KOH solution and a 1.0M H₂SO₄ solution. The RIEM 4 is electrically conductive such that it can work either as a bipolar electrode to decouple the anode and the cathode, or shuttle ions without electrochemical reactions occurring on either side.

It is known that for water splitting at 25° C., the electrolyzing voltage is 1.48V based on thermodynamic calculations. Thus, if the system of the present invention were viewed incorrectly as two electrochemical cells connected in tandem and separated by a bipolar electrode, a voltage of 2.96V (i.e., 2 times 1.48V) would be the minimal requirement to anchor water-splitting reactions. However, referring to FIGS. 11-12, this situation was ruled out experimentally, because the following voltages were applied, all under 2.96V: 2.0V, 2.2V, 2.5V, and 2.8V.

A solid titanium foil measuring 0.5 mil (12.5 μm) in thickness was subjected to hydrothermal oxidation in a 10M NaOH solution at elevated temperatures. The formation of surface TiO2 was confirmed by SEM/EDS, and permeation experiments indicated that the foil remained solid and waterproof. As a result, a RIEM 4 was created. FIG. 11 shows a representative chronoamperometric response of the Pt anode 8 to water electrolysis with a Ti foil membrane with and without hydrothermal oxidation. Upon applying a voltage to the two Pt electrodes 6, 8, a Faradaic current response was observed that related to water hydrolysis; the same was true for both the raw and oxidized membranes. Consequently, ionic exchange through the membrane occurred, forming a closed internal loop of charge motion, to couple the anodic and cathodic reactions. This observation was counter-intuitive, because the waterproof, solid feature of the RIEM 4 eliminated mass diffusion across that RIEM 4 due to a concentration gradient. Instead, this ionic exchange process was correlated to the redox reaction of TiO₂ that absorbed and desorbed hydroxyl ions. As a voltage was applied to the two Pt electrodes 6, 8, the RIEM 4 sandwiched between then was electrically conductive and bipolarized; that is, it worked as an anode by its oxidation to couple with the Pt cathode 6 while it synchronically worked a cathode by its reduction to couple with the Pt anode 8. On the other hand, the entire RIEM 4 was inclined to bear a potential-equivalent body due to its high electrical conductivity, which caused the oxidized and reduced forms of titanium to self-discharge until realizing an equilibrium. Taken together, cycling of the redox reactions of titanium or its oxides absorbed hydroxyl ions (OH⁻) from one side of the RIEM 4 and simultaneously released OH⁻ to the other side of the RIEM 4, creating an efficient ion-transporting pathway. This working mechanism was further studied by a control experiment wherein a raw membrane and an oxidized RIEM 4 were used in parallel for comparison. The oxidized RIEM 4 caused the water electrolysis to proceed with a much higher efficiency than did with a raw membrane under the same conditions, as was evidenced by the Faradaic response of 244.3 μA (blue curve) vs 22.4 μA (red curve) to the voltage of 2.2V (FIG. 11). The same relative kinetics were true when comparing the two membranes at the voltage of 2.8V.

The essential role of the redox-active species in transporting protons was studied by control experiments of water electrolysis in an acidic media wherein a Ti@TiO₂ RIEM 4 with and without an additional deposit of RuO₂ were studied in parallel. The Ti@TiO₂ membrane measured 0.8 millimeters in thickness and featured a nanoporous structure. FIG. 12 shows a representative chronoamperometric response to water electrolysis in 1.0M H₂SO₄ at 2.0V and 2.5V, with a Ti@TiO₂ membrane with and without a RuO₂ overlayer being sandwiched between the anode and cathode electrodes. The electrochemical configuration with a Ti@TiO₂ membrane alone (without RuO₂) was unable to anchor the water electrolysis reaction at either 2.0V or 2.5V (red curve in FIG. 12). This failure can be translated to dysfunction of the membrane in ionic conduction due to its special physical structure (thickness of 0.7 mm and pore size of tens of nm), thus decoupling the electrochemical reactions at the two electrodes. This situation would be worsened if an overlayer was deposited on the surface and/or in the membrane of Ti@TiO₂. However, FIG. 12 (blue curve) reproduces a significant Faradaic response that was causally linked to water electrolysis under controlled conditions. Comparison indicated a closed internal circuit via ionic conduction through RuO₂/Ti@TiO₂. This observation seemed counter-intuitional, in that the RuO₂ deposit on/in Ti@TiO₂ was expected to further disrupt the ionic conduction by serving as an additional barrier layer and/or reducing the pore size. Therefore, RuO₂/Ti@TiO₂ conducted ions via a working mechanism other than mass diffusion, migration, or convection. As discussed above for the anion membrane, the components in RuO₂/Ti@TiO₂ worked cooperatively to transport ions through the RIEM 4 based on the proton-involved redox reaction of RuO₂. It was noteworthy that the TiO₂ component, albeit featuring reversible redox in acidic media, was found not suited to work alone for ionic conduction under the conditions of our experiment because its redox potential positioned beyond the water-splitting voltage. Instead, the TiO₂ was nanoscaled to serve as a high-surface supporter of RuO₂ to achieve desired ion transport.

Based on the experiments above, Ti@TiO₂ and RuO₂/Ti@TiO₂ were chosen as an anion-conducting and cation-conducting membrane, respectively. A commercial titanium fiber felt disc (53%-56% porosity) measuring 25 mm in diameter and 0.25 mm in thickness was subjected to a hydrothermal reaction for 24 hours in a PTFE-lined autoclave reactor. The titanium surface was oxidized to titanium oxide nanowires that surround individual titanium fibers; the whole disc was converted to a nanoporous structure.

To evaluate the performance of that Ti@TiO₂ membrane, platinum coil electrodes were placed in an H-shaped vessel that was separated by that Ti@TiO₂ membrane. The chronoamperometric response in water electrolysis to a pre-determined voltage was recorded and compared to a device using a FUMASEP® brand AEM membrane of FUMATECH BWT GmbH, Bietigheim-Bissingen, Germany. FIG. 13 shows a typical chronoamperometric response to water electrolysis at 2.8V in a H-cell device with the Ti@TiO₂ membrane prepared above, compared to the same experimental setup using a FUMASEP® brand AEM membrane. The membrane composed of TiO₂ nanostructures on a Ti filter (1.0 μm porosity, 0.7 mm thickness), denoted as the Ti@TiO₂ membrane, exhibited an internal resistance comparable to the FUMASEP® brand AEM membrane, as evidenced by their overlapped current profile versus the time (red and purple curves). Upon reduction to 0.25 mm of the membrane's thickness, a membrane composed of TiO₂ nanostructures on a Ti felt, denoted as Ti@TiO₂-felt, led to a current response three times that using the Ti@TiO₂ membrane. The electrode-reaction kinetics were enhanced due to the thickness-dependent electrochemical impedance. Given a negligible barrier for electrons shutting in the titanium filter and felt network, the membrane thickness most likely defined the ionic transfer rate throughout the membrane, thereby determining the overall kinetics of the overall ion-involved redox reactions (that is, the ion-transporting kinetics). The same higher ion-transporting kinetics were true for the RuO₂/Ti@TiO₂ membrane working in acidic media when compared to a NAFION™ 212 brand membrane. FIG. 10 shows histograms for the hydrogen production rate of the different membranes in 1.0M KOH at 2.8V and 1.0M H₂SO₄ at 2.5V. A six-fold higher rate of hydrogen production was achieved using our Ti@TiO₂ membrane in H₂SO₄, while a nearly 25% higher hydrogen production rate was achieved for RuO₂/Ti@TiO₂ in KOH, in relation to their counterpart commercial membranes.

The use of the RIEM 4 in a process for generating hydrogen has been described above. It will be appreciated that the RIEM 4 is useful in other applications. As one application, the RIEM 4 may be used to separate electrodes and/or conduct ions in a fuel cell; a fuel cell is essentially a reverse process of the hydrogen-generating process described above. As another application, the RIEM 4 may be used in a metal air/oxygen battery, such as a zinc-air battery. As another application, the RIEM 4 may be used in a lithium-ion battery. As another application, the RIEM 4 may be used in an electrochemical supercapacitor or pseudo-supercapacitor.

As used in this document, and as customarily used in the art, terms of approximation, including the words “substantially” and “about,” are defined to mean normal variations in the dimensions, measurements and physical properties of items and processes in the physical world that may be associated with accuracy, precision, and/or tolerances.

While the invention has been described in detail, it will be apparent to one skilled in the art that various changes and modifications can be made and equivalents employed, without departing from the present invention. It is to be understood that the invention is not limited to the details of construction, the arrangements of components, and/or the method set forth in the above description or illustrated in the drawings. Statements in the abstract of this document, and any summary statements in this document, are merely exemplary; they are not, and cannot be interpreted as, limiting the scope of the claims. Further, the figures are merely exemplary and not limiting. Topical headings and subheadings are for the convenience of the reader only. They should not and cannot be construed to have any substantive significance, meaning or interpretation, and should not and cannot be deemed to indicate that all of the information relating to any particular topic is to be found under or limited to any particular heading or subheading. Therefore, the invention is not to be restricted or limited except in accordance with the following claims and their legal equivalents.

What is claimed is:

1. A redox ion exchange membrane, comprising:
an electrically-conductive material; and
redox-active materials associated with said electrically-conductive material, said redox-active materials having reversible oxidation and reduction properties.

2. The redox ion exchange membrane of claim 1, wherein said redox-active materials comprise inorganic nanostructures.

3. The redox ion exchange membrane of claim 2, wherein said inorganic nanostructures are oxides of the material composing said electrically-conductive material.

4. The redox ion exchange membrane of claim 2, wherein said electrically-conductive material comprises two opposed surfaces, and wherein said inorganic nanostructures comprise at least one layer on at least one said surface of said electrically-conductive material.

5. The redox ion exchange membrane of claim 1, wherein said inorganic nanostructures comprises at least one of the group consisting of: nanoparticles, nanofibers, nanotubes and nanowires.

6. The redox ion exchange membrane of claim 1, wherein said electrically-conductive material is porous.

7. The redox ion exchange membrane of claim 1, wherein said electrically-conductive material comprises at least one transition metal.

8. The redox ion exchange membrane of claim 1, wherein said electrically-conductive material comprises at least one of the group consisting of: transition metal oxides, transition metal sulfides, alkali metal salts, and transition metal salts.

9. The redox ion exchange membrane of claim 1, wherein said electrically-conductive material comprises titanium felt, and wherein said inorganic nanostructures comprise titanium nanowires covered at least in part with titanium oxide.

10. The redox ion exchange membrane of claim 1, wherein said electrically-conductive material is at least one of the group consisting of: carbon dots, graphite, graphene, carbon fibers, carbon nanotubes, carbon black, Fe, Co, Ni, Ti, Mn, Zr, Cr, RuO₂, IrO₂, CrO₂, and InSnO₂.

11. A hydrogen production device comprises
a cathode;
an anode; and
a redox ion exchange membrane positioned between said cathode and said anode, said redox ion exchange membrane having a first surface and a second surface opposed to said first surface.

12. The hydrogen production device of claim 11, wherein said cathode is immersed in a solution including water, and wherein said solution including water is in contact with said first surface of said redox ion exchange membrane.

13. The hydrogen production device of claim 11, wherein said anode is immersed in a solution including water, and wherein said solution including water is in contact with said second surface of said redox ion exchange membrane.

14. The hydrogen production device of claim 11, wherein said cathode and said anode each comprise at least one of a transition metal and an alloy of said transition metal.

15. A fuel cell device, comprising
a first electrode;
a second electrode; and
a redox ion exchange membrane positioned between said first and second electrodes, said redox ion exchange membrane having a first surface and a second surface opposed to said first surface.

16. The fuel cell device of claim 15, wherein said first and second electrodes are immersed in a solution including water, and wherein said solution including water is in contact with said first and second surface of said redox ion exchange membrane.

17. The fuel cell device of claim 15, wherein said first and second electrodes each comprise at least one of a noble metal and an alloy of said transition metal.

18. A method of producing hydrogen gas, comprising:
providing a cathode, an anode, and a redox ion exchange membrane positioned between said cathode and said anode, said redox ion exchange membrane having a first surface and a second surface opposed to said first surface; and
applying electrical power to said cathode and said anode;
wherein said applying causes simultaneous reciprocal reduction and oxidation reactions on opposite sides of said redox ion exchange membrane, such that H⁺ is released on one side of said redox ion exchange membrane.

19. The method of claim 16, wherein said simultaneous reciprocal reduction and oxidation reactions on opposite sides of said redox ion exchange membrane occur regardless of a concentration gradient across said redox ion exchange membrane.
